(19) United States
(12) Patent Application Publication
(10) Pub. No.: US 2009/0038393 A1
(43) Pub. Date: Feb. 12, 2009

(54) LIQUID LEVEL SENSING APPARATUS WITH SELF-DIAGNOSIS FUNCTION AND METHOD FOR SELF-DIAGNOSING THEREOF

(75) Inventors: Chun-chih Chaung, Changhua County (TW); Ming-Kung Ku, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PROMOS TECHNOLOGIES INC., Hsinchu (TW)

(21) Appl. No.: 12/057,348

(22) Filed: Mar. 27, 2008

(30) Foreign Application Priority Data
Aug. 7, 2007 (TW) 96129012

(51) Int. Cl. G01F 23/00

(52) U.S. Cl. 73/290 R

(57) ABSTRACT

A liquid level sensing apparatus with self-diagnosis function suitable for sensing liquid level in a storage tank is provided. The liquid level sensing apparatus includes a lifting apparatus, a separated tank, and a liquid level sensor. The separated tank is disposed on the lifting apparatus and communicates with the storage tank. The liquid level sensor is disposed inside the separated tank.

### CROSS-REFERENCE TO RELATED APPLICATION

This application claims the priority benefit of Taiwan application serial no. 96129012, filed on Aug. 7, 2007. The entirety of the above-mentioned patent application is hereby incorporated by reference herein and made a part of this specification.

### BACKGROUND OF THE INVENTION

1. Field of the Invention

The present invention relates to a liquid level sensing apparatus, and more particularly relates to a liquid level sensing apparatus with a self-diagnosis function.

2. Description of Related Art

In various conventional processes, different kinds of liquids are usually used. Those liquids are stored in storage tanks. When it is not perceived that the liquids have run out, usually the process fails, which results in the decrease of the yield.

For example, in a lithography process of semiconductor process, before a photoresist layer is coated on a semiconductor substrate, hexamethyldisilazane (HMDS) is sprayed on the semiconductor substrate, so as to enhance adhesion between the photoresist layer and the semiconductor substrate, and to prevent the collapse of the photoresist layer.

However, when it is not perceived that the HMDS in the storage tank has run out, the formed phororesist layer may not be adhered onto the semiconductor substrate easily, which results in the collapse of the photoresist layer, and the decrease of yield. Therefore, a liquid level sensor is usually disposed inside the storage tank, so as to ensure that a safe storage amount of the HMDS in the storage tank.

FIG. 1 is a schematic view of a conventional storage tank having a liquid level sensor.

Referring to FIG. 1, a storage tank 100 has a fiber optic liquid level sensor 102, and the fiber optic liquid level sensor 102 has three sensing points H/H, H/L, and L/L from top to bottom. Generally speaking, if the safe storage amount of the liquid in the storage tank 100 is set between the sensing point H/H and the sensing point H/L, compensation is carried out when the storage amount is lower than the sensing point H/L until the liquid in the storage tank 100 reaches the safe storage amount. The sensing point H/H is used to prevent the liquid in the storage tank 100 from exceeding the safe storage amount. In addition, when the sensing point H/L fails to function, the sensing point L/L may be used as a spare sensing point, so as to ensure that the liquid in the storage tank 100 will not run out. However, when the sensing points H/L and L/L fails to function at the same time, the process fails.

Therefore, in the conventional art, it is checked periodically whether the fiber optic liquid level sensor 102 functions normal or not. However, before checking whether the sensing points H/H, H/L, and L/L of the fiber optic liquid level sensor 102 function normal or not, the liquid in the storage tank 100 must be drained out, so as to obtain a liquid level lower than the sensing point L/L. Then, new liquid is injected again to check whether the sensing points L/L, H/L, and H/H function normal or not successively.

However, in the above method of checking whether the fiber optic liquid level sensor 102 functions normal, it is time consuming to draining out the liquid in the storage tank 100 and to inject the new liquid again. In addition, the liquid drained out will be discarded away, which is a waste of material and results in the increase of the production cost. Moreover, if the liquid drained out is a volatile liquid, such as, HMDS, it will contaminate the environment.

### SUMMARY OF THE INVENTION

Accordingly, the present invention is directed to providing a liquid level sensing apparatus with a self-diagnosis function, so as to effectively lower the production cost.

The present invention is also directed to providing a self-diagnosing method of a liquid level sensing apparatus with a self-diagnosis function, so as to quickly check whether the liquid level sensor functions normal.

The present invention provides a liquid level sensing apparatus with a self-diagnosis function, suitable for sensing a liquid level in a storage tank. The liquid level sensing apparatus includes a lifting apparatus, a separated tank, and a liquid level sensor. The separated tank is disposed on the lifting apparatus and communicates with the storage tank. The liquid level sensor is disposed inside the separated tank.

The present invention provides a self-diagnosing method of a liquid level sensing apparatus with a self-diagnosis function. The liquid level sensing apparatus includes a lifting apparatus, a separated tank disposed on the lifting apparatus, and a liquid level sensor disposed inside the separated tank, and the separated tank communicates with a storage tank storing a liquid. The self-diagnosing method of the liquid level sensing apparatus includes the following steps. Firstly, the lifting apparatus is used to adjust a height of the separated tank, so as to make a liquid level of the liquid in the separated tank fall in a liquid level sensing range of the liquid level sensor. Then, it is observed whether the liquid level sensor sends a sensing signal. If yes, it indicates that the liquid level sensor functions normal, and if no, it indicates that the liquid level sensor fails to function.

Based on the above, the liquid level sensing apparatus with a self-diagnosis function provided by the present invention uses the principle of connection pipe to perform self-diagnosis. Therefore, when the self-diagnosis is performed on the liquid level sensor, it is not necessary to drain out the liquid in the storage tank. Therefore, the waste of material and contamination to the environment can be avoided, and the production cost is effectively reduced.

Furthermore, the liquid level sensing apparatus with the self-diagnosis function provided by the present invention may ensure the liquid level sensor to function normal, so the process is carried out successfully, thereby preventing the process error.

On the other hand, the self-diagnosing method of the liquid level sensing apparatus with a self-diagnosis function of the present invention is quite convenient in operation, thus greatly reducing the time spent for checking the liquid level sensor.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional storage tank having a liquid level sensor.

FIG. 2 is a schematic view of a storage tank having a liquid level sensing apparatus according to an embodiment of the present invention.

FIGS. 3 to 5 are schematic views of the bottom of the separated tank and the bottom of the storage tank at different heights in FIG. 2.

FIG. 6 is a schematic view of the storage tank having the liquid level sensing apparatus according to another embodiment of the present invention.

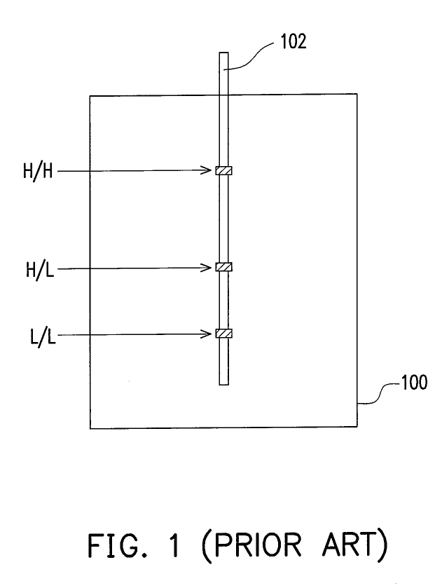

### DESCRIPTION OF EMBODIMENTS

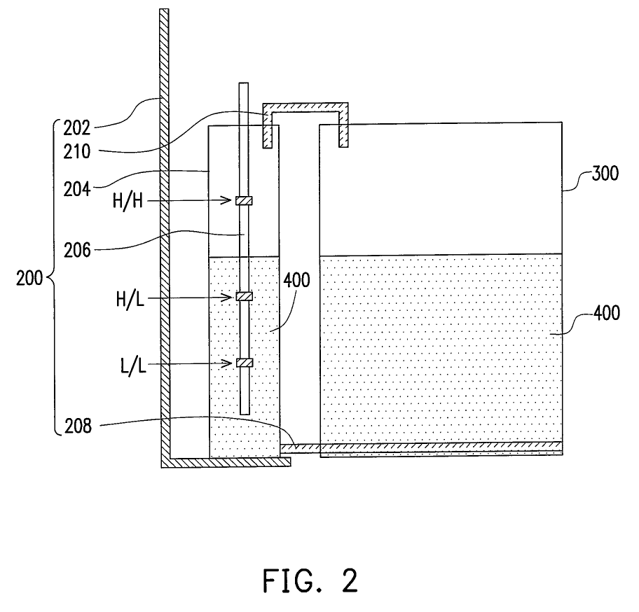

FIG. 2 is a schematic view of a storage tank having a liquid level sensing apparatus according to an embodiment of the present invention.

Referring to FIG. 2, a liquid level sensing apparatus with a self-diagnosis function 200 is suitable for sensing liquid level in a storage tank 300. The material of the storage tank 300 and a stored liquid 400 may be determined according to the requirements of the process, which will not be particularly limited herein.

The liquid level sensing apparatus 200 includes a lifting apparatus 202, a separated tank 204, a liquid level sensor 206, and connection pipes 208, 210. The lifting apparatus 202 is an apparatus capable of moving in vertical direction, for example, a lifting platform.

The separated tank 204 is disposed on the lifting apparatus 202 and communicates with the storage tank 300. Generally, when the liquid level of the liquid 400 in the storage tank 300 is monitored, the lifting apparatus 202 makes the bottom of the separated tank 204 and the bottom of the storage tank 300 at the same height. When the self-diagnosis is performed on the liquid level sensor 206, the lifting apparatus 202 may be used to adjust the height of the separated tank 204, so as to adjust the liquid level of the liquid 400 in the separated tank 204.

In this embodiment, the separated tank 204 is, for example, a closed tank body for storing various liquids 400, and the volatile liquid 400 and the easily polluted liquid 400 are often stored in the closed tank body. When the separated tank 204 is the closed tank body, the separated tank 204 communicates with the storage tank 300 through the connection pipes 208, 210. The connection pipe 208 enables communication between the bottom of the separated tank 204 and the bottom of the storage tank 300, so as to allow the liquid 400 in the separated tank 204 and the liquid 400 in the storage tank 300 to flow to the other tank. The connection pipe 210 enables communication between the top of the separated tank 204 and the top of the storage tank 300, so as to balance pressure difference between the separated tank 204 and the storage tank 300.

In addition, the capacity of the separated tank 204 is smaller than the capacity of the storage tank 300. For example, the height of the separated tank 204 is designed to be same as the height of the storage tank 300, and the cross-sectional area of the separated tank 204 is designed to be smaller than the cross-sectional area of the storage tank 300. Thus, the capacity of the separated tank 204 is smaller than the capacity of the storage tank 300, which is not intended to limit the height of the separated tank 204 of the present invention.

The liquid level sensor 206 is disposed inside the separated tank 204, for sensing the liquid level of the liquid 400 in the storage tank 300. The liquid level sensor 206 is not particularly limited as long as being a sensor capable of sensing the liquid level. In this embodiment, the liquid level sensor 206 is a fiber optic liquid level sensor having three sensing points H/H, H/L, and L/L for illustration. In other embodiments, the liquid level sensor 206 may be an electrode liquid level sensor, an optoelectronic liquid level sensor, a float liquid level sensor, a pneumatic liquid level sensor, an electrostatic capacitive liquid level sensor, a continuous float liquid level sensor, an ultrasonic liquid level sensor, a pressure liquid level sensor, or a weight liquid level sensor.

Based on the above, the liquid level sensing apparatus 200 uses the principle of connection pipe to adjust the liquid level of the liquid 400 in the separated tank 204, so as to perform the self-diagnosis on the liquid level sensor 206. Therefore, when the self-diagnosis is performed on the liquid level sensor 206, it is not necessary to drain out the liquid 400 in the storage tank 300. Therefore, the waste of material and the contamination to the environment can be avoided, and the production cost is effectively reduced.

In addition, the liquid level sensing apparatus 200 can ensure the liquid level sensor 206 to function normal, so the case that the liquid 400 stored in the storage tank 300 is run out before being perceived will not occur, and thus the process is carried out successfully, thereby preventing the process error.

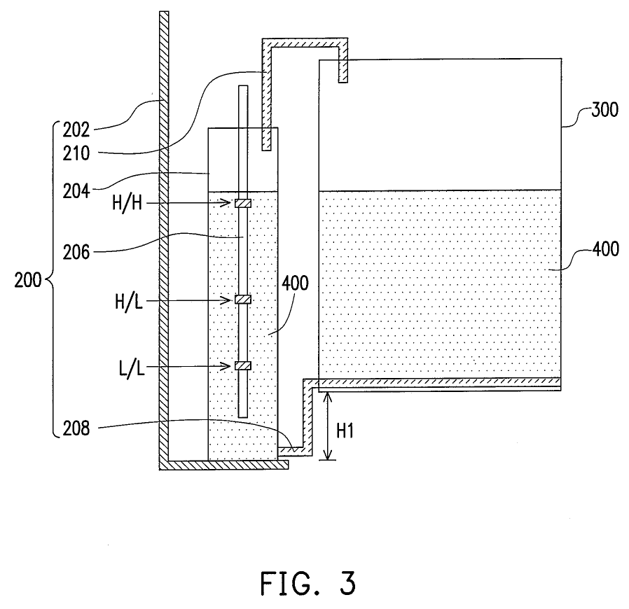

FIGS. 3 to 5 are schematic views of the bottom of the separated tank and the bottom of the storage tank at different heights in FIG. 2.

Hereinafter, FIGS. 2 to 5 are used to illustrate the self-diagnosing method performed by the liquid level sensing apparatus 200 on the liquid level sensor 206.

Firstly, referring to FIG. 2, generally, when the liquid level of the liquid 400 in the storage tank 300 is monitored, the lifting apparatus 202 may make the bottom of the separated tank 204 and the bottom of the storage tank 300 located at the same height. In this embodiment, the liquid level of the safe storage amount of the liquid 400 is set between the sensing points H/H and H/L. The liquid level sensing range of the sensing point H/H is located at the position above the sensing point H/H. The liquid level sensing range of the sensing point H/L is located at the position lower than the sensing point H/L. The liquid level sensing range of the sensing point L/L is located at the position lower than the sensing point L/L. However, those of ordinary skill in the art can adjust the liquid level of the safe storage amount and the liquid level sensing range of the liquid level sensor 206 according to the design requirements.

Then, referring to FIG. 3, when it is diagnosed whether the sensing point H/H functions normal or not, the lifting apparatus 202 is used to adjust the height of the separated tank 204. The lifting apparatus 202 makes the bottom of the separated tank 204 located at the position lower than the bottom of the storage tank 300, and the height difference between the two is H1. Thus, the liquid level of the liquid 400 in the separated tank 204 falls in the liquid level sensing range of the sensing point H/H. Then, it is observed whether the liquid level sensor 206 sends the sensing signal of the sensing point H/H or not. If yes, it indicates that the sensing point H/H functions normal. If no, it indicates that the sensing point H/H fails to function, the repair is needed.

In addition, before the liquid level of the liquid 400 in the separated tank 204 enters the liquid level sensing range of the sensing point H/H, it is observed whether the liquid level sensor 206 sends the sensing signal of the sensing point H/H. If yes, it indicates that the sensing point H/H fails to function, and if no, it indicates that the sensing point H/H functions normal.

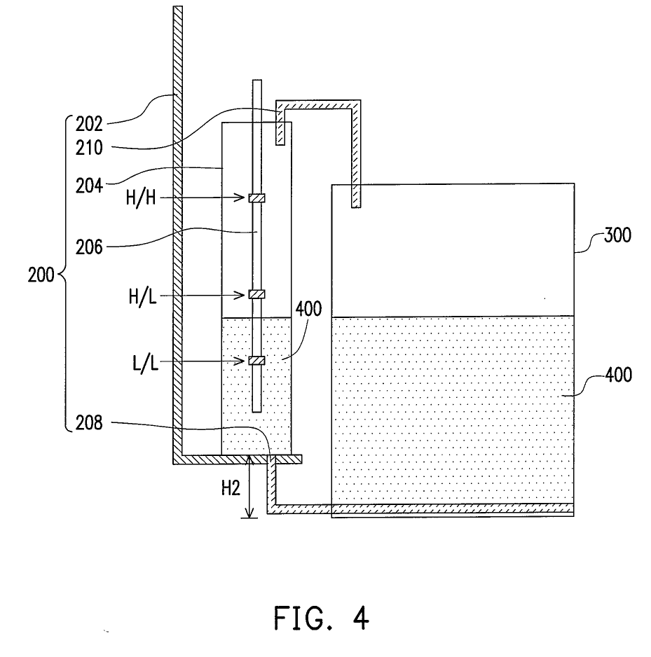

Next, referring to FIG. 4, when it is diagnosed whether the sensing point H/L functions normal, the lifting apparatus 202 is used to adjust the height of the separated tank 204. The lifting apparatus 202 makes the bottom of the separated tank 204 located at the position higher than the bottom of the storage tank 300, and the height difference between the two is H2. Thus, the liquid level of the liquid 400 in the separated tank 204 falls in the liquid level sensing range of the sensing point H/L. Then, it is observed whether the liquid level sensor 206 sends the sensing signal of the sensing point H/L or not. If yes, it indicates that the sensing point H/L functions normal, and if no, it indicates that the sensing point H/L fails to function, and the repair is needed.

In addition, before the liquid level of the liquid 400 in the separated tank 204 enters the liquid level sensing range of the sensing point H/L, it is observed whether the liquid level sensor 206 sends the sensing signal of the sensing point H/L. If yes, it indicates that the sensing point H/L fails to function, and if no, it indicates that the sensing point H/L functions normal.

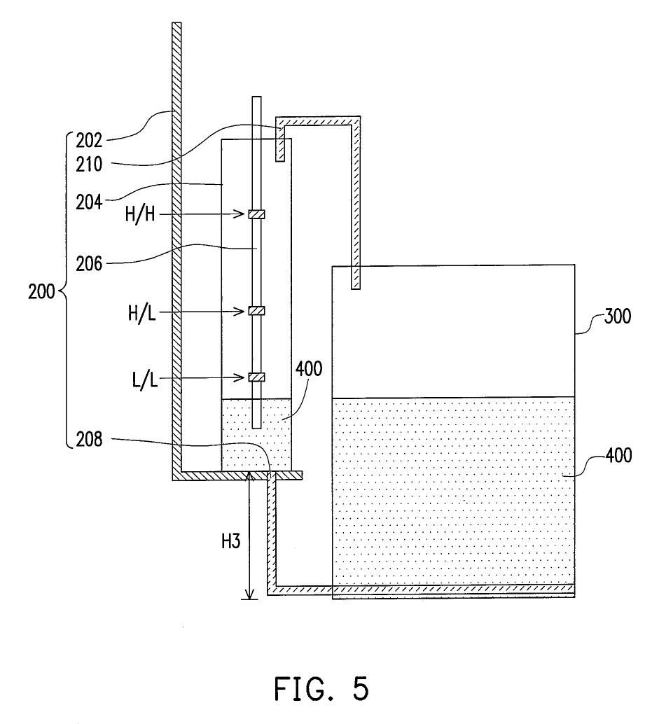

Next, referring to FIG. 5, when it is diagnosed whether the function of the sensing point L/L is normal, the lifting apparatus 202 is used to adjust the height of the separated tank 204. The lifting apparatus 202 makes the bottom of the separated tank 204 located at the position higher than the bottom of the storage tank 300, and the height difference between the two is H3. Thus, the liquid level of the liquid 400 in the separated tank 204 falls in the liquid level sensing range of the sensing point L/L. Then, it is observed whether the liquid level sensor 206 sends the sensing signal of the sensing point L/L. If yes, it indicates that the sensing point L/L functions normal, and if no, it indicates that the sensing point L/L fails to function, and the repair is needed.

In addition, before the liquid level of the liquid 400 in the separated tank 204 enters the liquid level sensing range of the sensing point L/L, it is observed whether the liquid level sensor 206 sends the sensing signal of the sensing point L/L. If yes, it indicates that the sensing point L/L fails to function, and if no, it indicates that the sensing point L/L functions normal.

It can be known from the above embodiment that the self-diagnosing method of the liquid level sensing apparatus 200 is quite simple and convenient in operation, thus effectively reducing the time spent for checking the liquid level sensor 206.

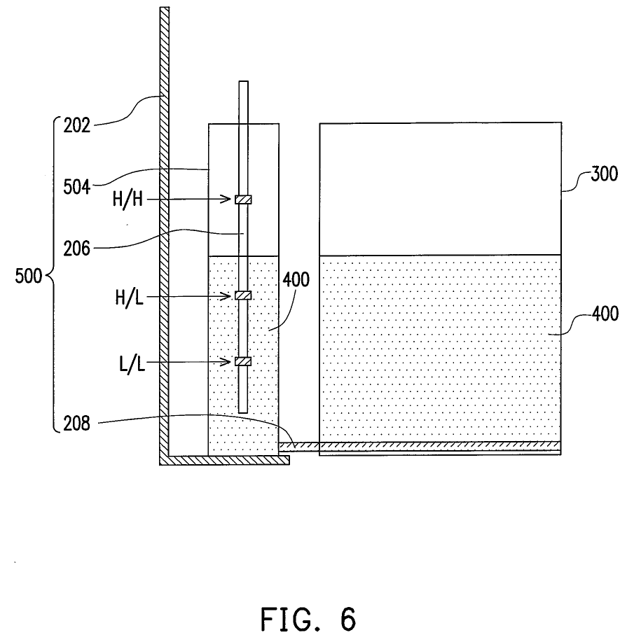

FIG. 6 is a schematic view of the storage tank having the liquid level sensing apparatus according to another embodiment of the present invention. Like element numerals in this figure are used to indicate like elements appearing in FIG. 2, and will not be described herein again.

Referring to FIG. 6, the embodiment of FIG. 6 is approximately the same as the embodiment of FIG. 2, except that a separated tank 504 of the liquid level sensing apparatus 500 of FIG. 6 is an open tank body. Therefore, it is not necessary to use the connection pipe 210 to balance the pressure difference between the separated tank 504 and the storage tank 300, and only the connection pipe 208 is used to enable communication between the bottom of the separated tank 504 and the bottom of the storage tank 300, such that the liquid 400 in the separated tank 504 and the liquid 400 in the storage tank 300 can flow to the other tank. The effects, benefits, and self-diagnosing method of the liquid level sensing apparatus 500 in FIG. 6 are approximately the same as those of the liquid level sensing apparatus 200 in FIG. 2, so it will not be described herein again.

To sum up, the present invention at least has the following advantages.

1. When the liquid level sensing apparatus with the self-diagnosing function provided by the present invention performs the self-diagnosis on the liquid level sensor, the waste of material and contaminant to the environment can be avoided, and the production cost is effectively reduced.

2. The liquid level sensing apparatus with the self-diagnosing function provided by the present invention is used to allow the process to be carried out successfully, and to prevent the process error.

3. The self-diagnosing method of the liquid level sensing apparatus with the self-diagnosing function provided by the present invention can greatly reduce the time spend for checking the liquid level sensor.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid level sensing apparatus with a self-diagnosis function, suitable for sensing liquid level in a storage tank, comprising:
a lifting apparatus;
a separated tank, disposed on the lifting apparatus and communicating with the storage tank; and
a liquid level sensor, disposed inside the separated tank.

2. The liquid level sensing apparatus with a self-diagnosis function as claimed in claim 1, wherein the lifting apparatus comprises a lifting frame.

3. The liquid level sensing apparatus with a self-diagnosis function as claimed in claim 1, wherein a capacity of the separated tank is smaller than a capacity of the storage tank.

4. The liquid level sensing apparatus with a self-diagnosis function as claimed in claim 1, wherein the separated tank comprises a closed tank body.

5. The liquid level sensing apparatus with a self-diagnosis function as claimed in claim 4, further comprising:
a first connection pipe, enabling communication between a bottom of the separated tank and a bottom of the storage tank; and
a second connection pipe, enabling communication between a top of the separated tank and a top of the storage tank.

6. The liquid level sensing apparatus with a self-diagnosis function as claimed in claim 1, wherein the separated tank comprises an open tank body.

7. The liquid level sensing apparatus with a self-diagnosis function as claimed in claim 6, further comprising a first connection pipe enabling communication between a bottom of the separated tank and a bottom of the storage tank.

8. The liquid level sensing apparatus with a self-diagnosis function as claimed in claim 1, wherein the liquid level sensor comprises a fiber optic liquid level sensor, an electrode liquid level sensor, an optoelectronic liquid level sensor, a float liquid level sensor, a pneumatic liquid level sensor, an electrostatic capacitive liquid level sensor, a continuous float liquid level sensor, an ultrasonic liquid level sensor, a pressure liquid level sensor, or a weight liquid level sensor.

9. A self-diagnosing method of a liquid level sensing apparatus with a self-diagnosis function, wherein the liquid level sensing apparatus comprises a lifting apparatus, a separated tank disposed on the lifting apparatus, and a liquid level sensor disposed inside the separated tank, the separated tank communicates with a storage tank storing a liquid, the method comprising:
using the lifting apparatus to adjust a height of the separated tank, so as to make a liquid level of the liquid in the separated tank fall in a liquid level sensing range of the liquid level sensor; and
observing whether the liquid level sensor sends a sensing signal, wherein if yes, it indicates that the liquid level sensor functions normal, and if no, it indicates that the liquid level sensor fails to function.

10. The self-diagnosing method of the liquid level sensing apparatus with a self-diagnosis function as claimed in claim 9, further comprising observing whether the liquid level sensor sends the sensing signal before the liquid level of the liquid in the separated tank enters the liquid level sensing range of the liquid level sensor, wherein if yes, it indicates that the liquid level sensor fails to function, and if no, it indicates that the liquid level sensor functions normal.

11. The self-diagnosing method of the liquid level sensing apparatus with a self-diagnosis function as claimed in claim 9, wherein the lifting apparatus comprises a lifting frame.

12. The self-diagnosing method of the liquid level sensing apparatus with a self-diagnosis function as claimed in claim 9, wherein a capacity of the separated tank is smaller than a capacity of the storage tank.

13. The self-diagnosing method of the liquid level sensing apparatus with a self-diagnosis function as claimed in claim 9, wherein the separated tank comprises a closed tank body.

14. The self-diagnosing method of the liquid level sensing apparatus with a self-diagnosis function as claimed in claim 13, wherein the liquid level sensing apparatus further comprising:
a first connection pipe, enabling communication between a bottom of the separated tank and a bottom of the storage tank; and
a second connection pipe, enabling communication between a top of the separated tank and a top of the storage tank.

15. The self-diagnosing method of the liquid level sensing apparatus with a self-diagnosis function as claimed in claim 9, wherein the separated tank comprises an open tank body.

16. The self-diagnosing method of the liquid level sensing apparatus with a self-diagnosis function as claimed in claim 15, wherein the liquid level sensing apparatus further comprising a first connection pipe enabling communication between a bottom of the separated tank and a bottom of the storage tank.

17. The self-diagnosing method of the liquid level sensing apparatus with a self-diagnosis function as claimed in claim 9, wherein the liquid level sensor comprises a fiber optic liquid level sensor, an electrode liquid level sensor, an optoelectronic liquid level sensor, a float liquid level sensor, a pneumatic liquid level sensor, an electrostatic capacitive liquid level sensor, a continuous float liquid level sensor, an ultrasonic liquid level sensor, a pressure liquid level sensor, or a weight liquid level sensor.
